(19) United States
(12) Patent Application Publication
(10) Pub. No.: US 2025/0277937 A1
(43) Pub. Date: Sep. 4, 2025

(54) Protected Optics Component and Production Method

(71) Applicant: Printoptix GmbH, Stuttgart (DE)

(72) Inventors: Simon Thiele, Stuttgart (DE); Nils Fahrbach, Stuttgart (DE)

(21) Appl. No.: 18/859,863

(22) PCT Filed: Apr. 5, 2023
(86) PCT No.: PCT/EP2023/059016

§ 371 Date: Oct. 24, 2024

(30) Foreign Application Priority Data
Apr. 25, 2022 (DE) 10 2022 109 831.1

(51) Int. Cl. G02B 6/26

(52) U.S. Cl. CPC G02B 6/262

(57) ABSTRACT

Micro-optics, in particular for connection to an optical fiber or a substrate, including an optics module. The optics module has at least one optical element and at least one cavity directly adjacent to one side of the optical element, and a sleeve completely surrounding the optics module. The sleeve and the optics module being connected to one another by a light-impermeable adhesive. A aperture of the optics module being formed by the light-impermeable adhesive.

### CROSS-REFERENCE TO RELATED APPLICATIONS

This application is the United States national phase of International Application No. PCT/EP2023/059016 filed Apr. 5, 2023, and claims priority to German Patent Application No. 10 2022 109 831.1 filed Apr. 25, 2022, the disclosures of which are hereby incorporated by reference in their entireties.

### BACKGROUND OF THE INVENTION

### Field of the Invention

Complex micro-optics can be extremely sensitive mechanically, especially if they have been manufactured from a polymer material using 3D printing. For many applications, the connection of such optics with optical fibers is essential. Optics attached to the fiber tip in this way can fall off, become deformed or scratched by even light contact. In addition, air spaces between the individual optical elements must often be maintained for the optical function in order to create a sufficient refractive index difference. This means that no liquids may penetrate into these intermediate spaces/cavities.

### Description of Related Art

However, the difficulty here, particularly with micro-optics, which are produced from a liquid polymer material using 3D printing through targeted local curing, is that the uncured polymer material, which is located in the cavities and is still liquid, must be removed from these cavities. This creates a complex structure as described, for example, in EP 3 162 549, wherein the cavities each have channels to remove the uncured liquid polymer material from the cavities.

In addition, it is necessary for the micro-optics to be shielded against stray light from the side in order to function optimally. However, in particular with micro-optics produced using 3D printing, the channels for removing the uncured polymer material from the cavities prevent complete and efficient coating. In particular, EP 3 162 549 A1 therefore does not have a complete coating, so that stray light can still enter the optics from the side, which can have a negative effect on the quality of the image of the micro-optics.

### SUMMARY OF THE INVENTION

The object of the present invention is to provide improved micro-optics, in particular manufactured by a simplified method.

The object is achieved with micro-optics as described herein as well as a method for manufacturing such micro-optics as described herein.

The micro-optics according to the invention comprises an optics module which is substantially cylindrical, in particular. The optics module has at least one optical element and at least one cavity directly adjacent to one side of the optical element. The optical element is, for example, a lens, a lens system, a filter or the like. By providing the cavity directly adjacent to the optical element, a sufficient refractive index difference is created. The refractive index difference between the refractive index of the cavity and the refractive index of the optical element is in particular greater than 0.3, preferably greater than 0.4 and particularly preferably greater than 0.5.

Furthermore, according to the invention, the micro-optics have a sleeve which completely surrounds the optics module. The sleeve according to the present invention is a separate component. The sleeve protects the optics module of the micro-optics from mechanical influences, so that damage such as breakage, scratching of the optical surfaces in particular and/or deformation of the optics module is prevented. In accordance with the invention, the sleeve and the optics module are connected to one another with a light-impermeable adhesive and, in particular, bonded. Here, “light-impermeable” refers to the property of the adhesive due to which light in the near infrared range, in the visible spectral range and/or in the near UV range substantially cannot pass through the material of the adhesive. In this context, substantially means less than 50% of the light passes through the impermeable adhesive, preferably less than 25%, more preferably less than 10% and particularly preferably less than 5%. The light-impermeable adhesive also forms an aperture of the optics module. The aperture can be the at least one optical element of the optics module or an additional optical element. On the one hand, this means that the light-impermeable adhesive connects the optics module to the sleeve, so that the sleeve protects the optics module from damage by providing mechanical protection. At the same time, the light-impermeable adhesive is used to create an aperture. Furthermore, the light-impermeable adhesive ensures that no stray light can enter the optics between the sleeve and the optics module, thus achieving effective shielding by the light-impermeable adhesive.

Preferably, the optical element has dimensions or expansions in the lower millimeter to micrometer range, i.e. dimensions smaller than 2 mm, for example smaller than 1000 μm and preferably smaller than 600 μm. The optics module can also have a corresponding dimension (diameter/side length) of less than 2 mm, preferably less than 1000 μm and particularly preferably less than 600 μm.

Preferably, the optics module is a monolithic component that is constructed in a single piece.

Preferably, the optics module is produced by 3D printing so that the optical elements, support elements around the respective cavity and other, particular complex structures of the optics module can be produced in a simple manner. The three-dimensional structure of the optics module is formed and printed using a 3D printer on the basis of a predetermined or specified layout or design, respectively. The 3D printer can, for example, be a 3D lithography system, in particular a 3D laser lithography system or a 3D multi-photon laser lithography system, which is preferably based on a 2-photon polymerization of a UV-curing photoresist or creates three-dimensional complex structures therefrom, respectively. For this purpose, the liquid resin is cured at certain points specified by the 3D design. The remaining liquid resin is removed to preserve the 3D structure.

The optics module is preferably transparent. In particular, the optics module is made from a transparent polymer. In particular, if the optics module is produced using a 3D printing process, a transparent resin is used for this purpose. This means that the optics module is also transparent. Here, “transparent” refers to the property of the material of the optics module due to which light in the near infrared range, in the visible spectral range and/or in the near UV range substantially can pass through the material of the optics module. In this context, substantially means that more than 50% of the light passes the material, preferably more than 75%, more preferred more than 90% and particularly preferred more than 95%. This results in the need for lateral shielding against stray light, which is provided by the light-impermeable adhesive surrounding the sleeve and the optics module and/or by the sleeve.

Preferably, a first end face of the optics module is directly connected to an optical fiber or a substrate. A second end face, which is opposite the first end face, can be configured as an exit facet or entry facet of the optics module.

Preferably, the sleeve extends axially beyond the optics module and comprises a section of the optical fiber. This improves the mechanical stability of the connection between the optics module and the optical fiber.

Preferably, more than one cavity is provided, with the optical element in particular being directly adjacent to a cavity on both sides.

Preferably, a cavity is formed between the optical element of the optics module and a fiber end or substrate, respectively. As a result, the cavity is limited on a first side by the optical element and on an opposite second side by the fiber end or the substrate, respectively, which prevents the penetration of liquid into the cavity.

Preferably, the cavity is formed between the optical element and an end face of the optics module. For example, the end surface can be the exit/entry facet of the optics module, which thus limits the cavity and prevents liquid from penetrating into the cavity.

Preferably, an annular gap is formed between the optics module and the sleeve, wherein the annular gap is in particular completely filled by the adhesive. In doing so, the adhesive penetrates into the annular gap by capillary action and thus spreads between the optics module and the sleeve to connect them to each other. Preferably, the annular gap completely surrounds the optics module, so that the light-impermeable adhesive also completely connects the optics module to the sleeve.

Preferably, the optics module has spacer elements, wherein the spacer elements extend radially outwards and are in direct contact with the sleeve. In particular, the annular gap is formed by the spacer elements. At the same time, the spacer elements serve to radially fix the position of the optics module within the sleeve, so that in particular a concentric alignment of the optics module within the sleeve is achieved before bonding by means of the light-impermeable adhesive. Here, at least three spacer elements are provided, which are arranged on the optics module. Preferably, more spacer elements are provided. In particular, the radial length of the spacer elements starting from the surface of the optics module just corresponds to the width of the annular gap. In particular, the spacer elements have a width dimension of 1-20 μm and preferably 1-10 μm. In particular, the spacer elements are the only direct connection between the optics module and the sleeve, whereas otherwise there is only an indirect connection between the optics module and the sleeve through the light-impermeable adhesive.

Preferably, the width of the annular gap is less than 50 μm, preferably less than 30 μm, more preferably less than 20 μm and particularly preferably less than 10 μm.

Preferably, the sleeve is a metal sleeve and/or a light-impermeable sleeve. In particular, the sleeve is made of a different material than the optics module. A metal sleeve in particular ensures high mechanical stability, which protects the optics module from damage. At the same time, a light-impermeable sleeve efficiently prevents stray light from the side. In particular, since the sleeve completely surrounds the optics module, the optics module is at the same time completely protected and shielded against the lateral penetration of stray light.

Preferably, the sleeve has a thickness of 20 μm to 250 μm, preferably 20 μm to 150 μm and particularly preferably 20 μm to 100 μm. The thickness of the sleeve indicates the wall thickness.

Preferably, the light-impermeable adhesive is a two-component adhesive with a colorant and/or particles that create the light impermeability of the adhesive.

Preferably, the aperture is formed by an annular recess in the optics module, which is filled with the light-impermeable adhesive. The annular recess is open on the radial outer surfaces of the optics module so that adhesive, which is spread between the sleeve and the optics module, can flow into the annular recess. This is also achieved by a capillary effect, in particular.

Preferably, the annular recess extends radially inwards over more than 20%, preferably more than 50% and particularly preferably more than 80% of the radius of the optics module. The aperture opening is then formed by the remaining part of the transparent optics module, which is surrounded by the light-impermeable adhesive in an annular manner.

Preferably, the annular recess has a vent hole or air equalization hole, respectively, in order to expel the air displaced by the adhesive entering the annular recess and thereby ensure that the annular recess is completely filled. For this purpose, the vent hole is arranged in particular on the radially inner end of the annular recess. In particular, the vent hole is arranged such that the vent hole connects the annular recess with the at least one cavity, so that the air displaced in the annular recess by the adhesive is directed into the at least one cavity.

Preferably, the diameter of the ventilation hole is selected so that air can pass through, but the adhesive cannot pass due to its viscosity and surface tension. In particular, the ventilation hole has a diameter of less than 10 μm, more preferably 5 μm and particularly preferably 1 μm.

Preferably, the adhesive does not enter the at least one cavity. Thus, the cavity is still filled with air or a gas in order to obtain the required calculation index difference between the optical element and its environment, in particular the cavity.

Preferably, the at least one cavity has at least one opening, which extends in particular in the circumferential direction and is open towards the outside of the optics module. If the optics module has a cylindrical shape, for example, the opening of the at least one cavity is arranged on the shell surface of the optics module. In particular, several openings are provided, which are distributed along the circumferential direction. The opening makes it possible to remove resin that has not cured during the manufacturing process from the cavity. The opening thus creates a connection from the inside of the cavity to the outside in order to remove the uncured photoresist.

Preferably, a pressure in the at least one cavity compensates for the capillary force of the adhesive, so that penetration of the adhesive into the cavity is prevented due to the increased pressure in the cavity. The pressure in the cavity is created by the air displaced by the adhesive when filling the annular gap and/or annular recess to create the aperture. This creates a pressure equilibrium so that further penetration of the adhesive into the respective cavity is just prevented.

Preferably, the at least one opening, several openings or all openings of the at least one cavity have a contact element.

Preferably, the contact element has a weakly wetting point to suppress the capillary effect of the adhesive. This weakly wetting point can be created, for example, by surface treatment of the contact element. Due to the weakly wetting properties of the surface of the contact element to reduce the adhesive forces, the capillary effect can be suppressed and thus unintentional filling of the at least one cavity by the light-impermeable adhesive can be prevented. By reducing the adhesion forces, the contact angle of the adhesive is increased, which reduces the capillary effect.

Preferably, the contact element has an inclined surface to suppress the capillary effect of the adhesive. Due to the inclined surface, the contact angle of the adhesive changes so that further penetration of the adhesive through the opening into the cavity of the optics module is no longer possible. In particular, the inclined surface faces radially outwards. In particular, the inclined surface has an angle to the axial direction of the optics module that is less than or equal to the contact angle of the adhesive and is preferably between 5° and 35° and in particular 10° to 30°. The inclined surface of the contact element thus ensures that the cavities still remain and are not filled by the light-impermeable adhesive that connects the optics module to the sleeve. At the same time, it is not necessary to provide separate channels connecting the cavities to the environment to remove the uncured photoresist. Rather, openings can be provided, but these are formed so that the light-impermeable adhesive does not enter the at least one cavity through the openings.

This significantly simplifies the design of the optics module. At the same time, it is possible to completely surround the optics module with a sleeve or a light-impermeable adhesive, respectively, thus preventing stray light from penetrating from the side. In combination with the aperture provided according to the invention, this results in improved optical properties with a simplified structure at the same time.

A further aspect of the present invention relates to a method of manufacturing a micro-optics comprising the steps of:
providing an optics module, wherein the optics module has at least one optical element and at least one cavity directly adjacent to one side of the optical element;
providing a sleeve;
inserting the optics module into the sleeve;
inserting a light-impermeable adhesive between the sleeve and the optics module, the adhesive spreading between the sleeve and the optics module by means of the capillary effect and forming an aperture.

Preferably, the micro-optics is designed as described above.

Preferably, the adhesive does not penetrate into the at least one cavity.

Preferably, the method comprises curing the light-impermeable adhesive, for example by drying, exposure to heat and/or exposure to light, for example by means of UV light. Alternatively, it can be a chemically initiated polymerization, such as with a 2-component adhesive.

Preferably, the method has additional steps in that after inserting the light-impermeable adhesive and, in particular, curing the light-impermeable adhesive, at least one end surface of the micro-optics is polished in order to produce an end facet of the micro-optics.

Preferably, the step of providing an optics module comprises manufacturing the optics module by means of 3D printing, in particular by means of 2-photon absorption of a UV-curing polymer/photoresist.

Preferably, the method is further developed using the features of the micro-optics described above.

### BRIEF DESCRIPTION OF THE DRAWINGS

The terms Fig., Figs., Figure, and Figures are used interchangeably to refer to the corresponding figures in the drawings.

In the following, the invention is described in more detail by means of preferred embodiments with reference to the accompanying drawings.

The Figures show:

FIG. 1 shows a first embodiment of the present invention,

FIG. 2 shows the embodiment of FIG. 1 in the assembled state,

FIG. 3 shows the embodiment of FIG. 2 in a sectional view,

FIG. 4 shows the embodiment of FIG. 1 in the fully assembled state as a sectional view,

FIGS. 5A, 5B show a detailed view of the contact element according to the present invention,

FIGS. 6A-6F show a further embodiment of the present invention, and

FIGS. 7A, 7B show a further embodiment of the present invention.

### DESCRIPTION OF THE INVENTION

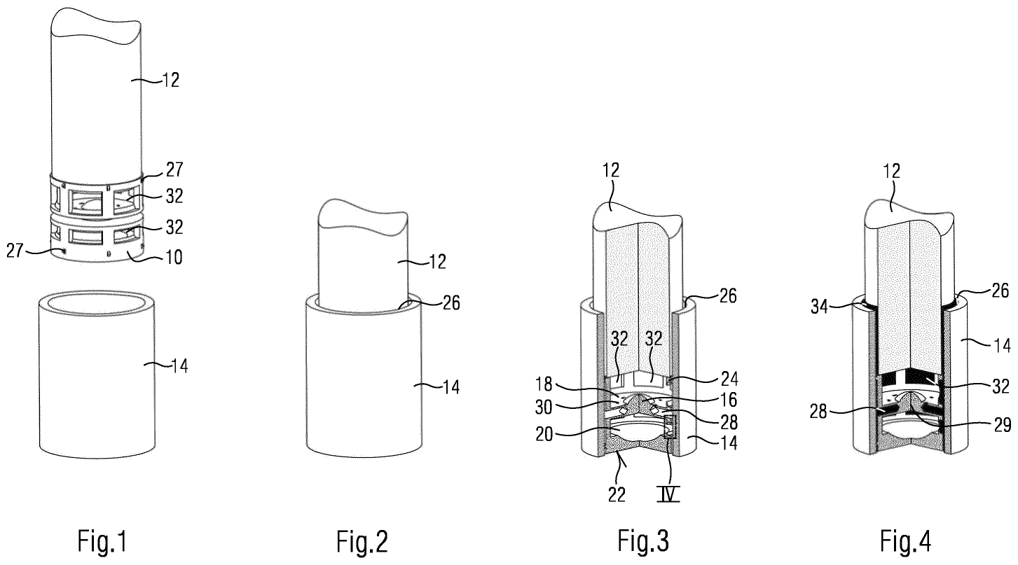

In the following, reference is made to the embodiment of FIGS. 1-4. FIG. 1 shows an optics module 10 which is attached directly to an end facet of an optical fiber 12 or is produced directly on the end of optical fiber 12, in particular by means of 3D printing. For this purpose, a liquid photoresist is selectively cured locally in the 3D printing process, for example by a 3D lithography process and in particular by means of a 3D laser lithography process, which is based, for example, on a 2-photon absorption of a UV-curing photoresist. This achieves a direct connection between optics module 10 and optical fiber 12. Furthermore, the micro-optics has a sleeve 14, which is designed, for example, as a metal sleeve and/or light-impermeable sleeve. Optics module 10 is inserted into the sleeve together with the fiber as shown in FIG. 2. In doing so, sleeve 14 completely surrounds optics module 10. This provides the optics module with optimum protection against mechanical influences. Furthermore, sleeve 14 also surrounds a portion of optical fiber 12, so that the axial length of sleeve 14 in the exemplary embodiment of FIGS. 1-4 is greater than the axial length of optics module 10 to produce the partial overlap of sleeve 14 with optical fiber 12. The overlap of the sleeve provides mechanical protection for the connection between optics module 10 and optical fiber 12. Furthermore, the light-impermeable sleeve 14 prevents stray light from entering from the side, which improves the imaging properties of optics module 10. In particular in the case that optics module 10 is made of a transparent polymer, the light-impermeable sleeve can prevent a negative influence on the optical performance of optics module 10 caused by laterally incident stray light.

In particular, optics module 10 is substantially cylindrical. The diameter of optics module 10 substantially corresponds to the diameter of optical fiber 12.

Furthermore, the optics module is in particular monolithic, i.e. formed as a single piece.

Preferably, optics module 10 is produced by 3D printing.

Optics module 10 according to FIG. 1 has spacer elements 27 on its outer side, which are distributed along the circumference. When optics module 10 is inserted into sleeve 14, these spacer elements 27 come into contact with the inner surface of sleeve 14, whereby optics module 10 is centered, aligned and, if necessary, clamped within sleeve 14, for example by means of a frictional connection.

Optics module 10 shown in FIG. 3 has at least one optical element 16, which is designed as a lens according to FIG. 3. The optical element is directly adjacent to a cavity 18 arranged above optical element 16 and a cavity 20 arranged below optical element 16. These cavities 18, 20 are filled with air or another gas in order to achieve a suitable refractive index difference between the medium of cavity 18, 20 and optical element 16. This enables the light to be suitably directed within optics module 10. In particular, sufficient focusing can be achieved by lens 16 to compensate, for example, for the divergence of the light emerging from the end facet of optical fiber 12 and to obtain substantially collimated light. Conversely, the light that passes through optics module 10 can be efficiently coupled into optical fiber 12 due to the focusing achieved by lens 16.

Furthermore, optics module 10 has an end facet 22, which closes off lower cavity 20 and thus protects it against the penetration of liquid. End facet 22 can be polished, for example. Through end facet 22, light enters the fiber through the optics module or light can exit optical fiber 12 through optics module 10 from end facet 22, respectively.

As can be seen from FIG. 1, the cavities 18, 20 each have outwardly open openings 32, i.e. openings in the shell surface of optics module 10. In the manufacturing process, optics module 10 is produced from a photoresist. Uncured photoresist must be removed from the cavities 18, 20 through the openings 32. In particular, the openings have a size of 0.3-0.9*U/n, where U refers to the circumference of the shell surface and n to the number of openings. In particular, the openings have an axial height of 10 μm to 250 μm and preferably 50 μm to 100 μm.

An annular gap 26 is formed between sleeve 14 and optical fiber 12 or optics module 10, respectively. Depending on the size of the module, said annular gap 26 has a thickness of between 3 μm and 100 μm, for example. To connect optics module 10 to sleeve 14 and optical fiber 12 to sleeve 14, an adhesive is introduced into annular gap 26 and spreads therein by the capillary effect.

Optics module 10 has an annular recess 28. The adhesive, which is used to bond optics module 10 to sleeve 14, also penetrates into annular recess 28 due to the capillary effect. In particular, this is a light-impermeable adhesive. The light-impermeable adhesive forms an aperture which, in the example of FIG. 4, at least partially surrounds optical element 16. In particular, annular gap 28 extends over at least 50%, preferably at least 70% and particularly preferably at least 90% of the radius of optics module 10. This creates an aperture opening 29 so that light can pass through aperture opening 29 and through optical element 16. The light-impermeable adhesive therefore fulfills two objects at the same time: Firstly, the light-impermeable adhesive creates a connection between optics module 10 and sleeve 14. At the same time, the light-permeable adhesive forms a aperture. Furthermore, the light-impermeable adhesive completely surrounds optics module 10 so that stray light entering from the side is also shielded by the light-impermeable adhesive.

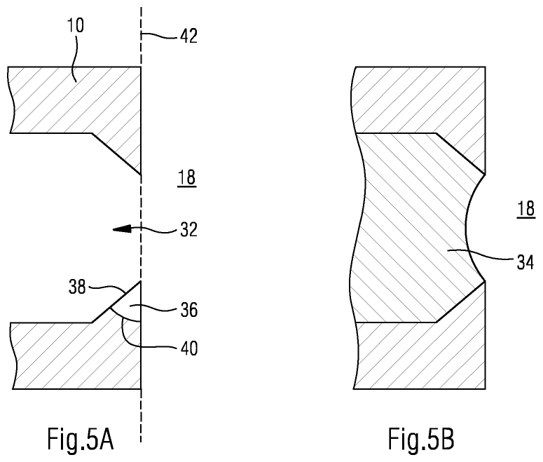

However, by providing the openings 32 for removing the uncured photoresist in the manufacturing process of optics module 10, there is the problem that the light-impermeable adhesive may not penetrate through opening 32 into the cavities 18, 20. For this purpose, a contact element is provided on the edges of opening 32. In the embodiment shown in FIGS. 5A, 5B, contact element 36 has an inclined surface 38 facing radially outwards. Inclined surface 38 of contact element 36 changes the contact angle between optics module 10 and the light-impermeable adhesive flowing in due to the capillary effect, so that no light-impermeable adhesive can pass through opening 32 into the cavities 18, 20. This is illustrated in FIG. 5B. Due to contact element 36, the light-impermeable adhesive 34 forms a meniscus and does not pass through opening 32. In particular, inclined surface 38 has an angle relative to axial direction 42 of the optics module of between 15° and 45° and in particular between 20° and 35°.

As shown in FIG. 3, the annular recess has at least one, but ideally a plurality of vent holes 30 or air equalization holes, respectively, which connect annular recess 28 with cavity 18. The vent holes 30 allow air to escape from annular recess 28, which is displaced by the light-impermeable adhesive flowing in, into cavity 18 in order to achieve complete filling of annular recess 28 by the light-impermeable adhesive. This increases the pressure in cavity 18, wherein the increased pressure in turn counteracts the flow of the light-impermeable adhesive through opening 32 into cavity 18.

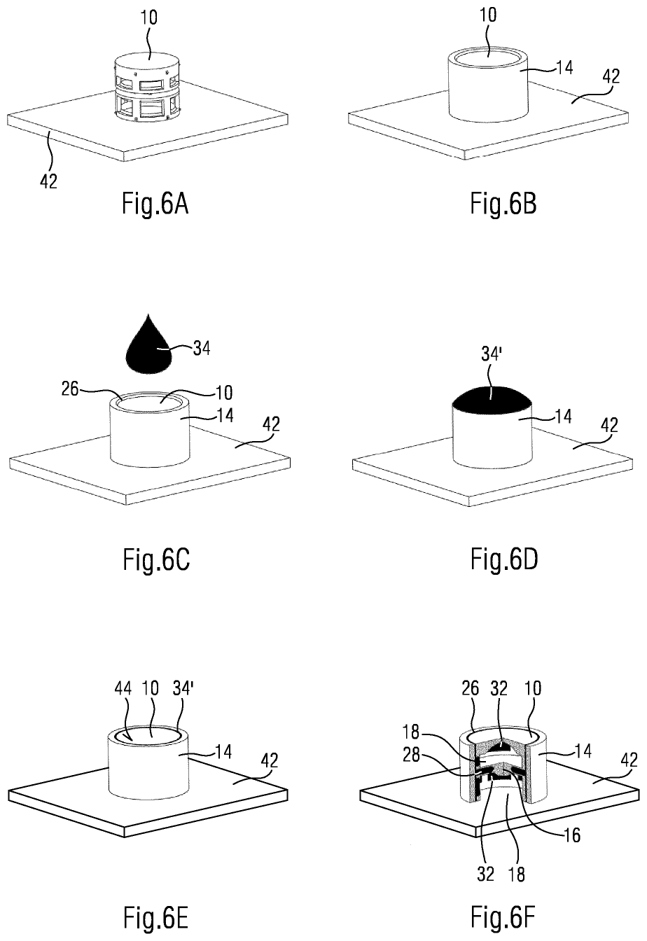

In the following, reference is made to the embodiment of FIGS. 6A to 6F. Identical or similar features are identified with identical reference numerals.

In the embodiment of FIGS. 6A-6F, an optics module 10 is disposed on a substrate 42. According to FIGS. 6A and 6F, the structure of optics module 10 substantially corresponds to the features of the embodiment of FIGS. 1-4. In particular, an optical element 16 is provided, which is directly connected to or adjacent to a cavity 18 on both sides, respectively. Furthermore, an annular recess 28 is provided by means of which a aperture is formed.

Optics module 10 is inserted into a sleeve 14 as shown in FIG. 6B. This creates an annular gap 26. According to FIGS. 6C and 6D, a liquid light-impermeable adhesive 34 is applied to an end face of the micro-optics and cured, wherein the cured adhesive being designated with 34′. The end face of the micro-optics is then polished to produce a polished light exit/entry surface as shown in FIG. 6E. According to FIG. 6F, the light-impermeable adhesive 34′ fills annular recess 28, thereby forming an aperture. At the same time, the light-impermeable adhesive 34′ connects sleeve 14 to optics module 10 so that sleeve 14 protects optics module 10 from damage.

In particular, one of the cavities 18 is limited on one side by the aperture and optical element 16 and on the other side by substrate 42, wherein substrate 42 prevents liquid from penetrating into the cavity.

Further features of the embodiment of FIGS. 6A-6F correspond or may correspond to the features as described above with respect to the embodiment of FIGS. 1-5, the claims or the general description.

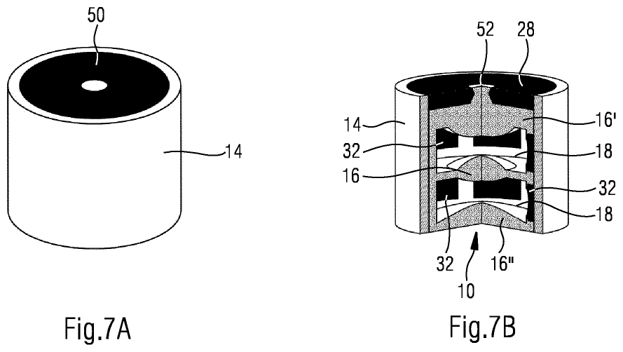

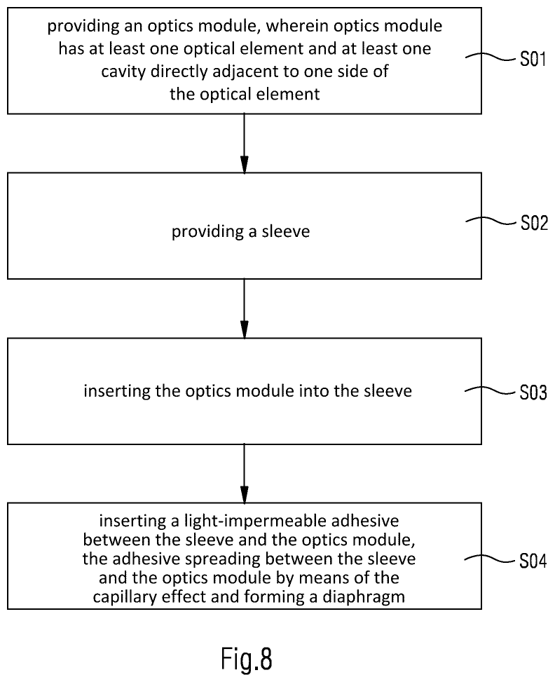

In the following, reference is made to the embodiment of FIGS. 7A to 7B. Here, the embodiment of FIGS. 7A and 7B differs in that the annular recess is provided on an end face 50 of the micro-optics. A light-impermeable adhesive can again be applied and spread through an annular gap between optics module 10 and sleeve 14. At the same time, an aperture is created on end face 50 with an aperture opening 52 through which light can enter or exit. In particular, end face 50 can be created by polishing.

Furthermore, the micro-optics according to FIG. 7B has three optical elements 16′, 16″ and 16, all of which are designed as lenses. The lenses are separated from each other by a cavity, whereby a sufficient refractive index difference between the respective optical elements is achieved.

In the following, reference is made to FIG. 8. FIG. 8 shows a schematic procedure of a method for manufacturing the micro-optics according to the invention.

In step S01, an optics module is provided, wherein the optics module has at least one optical element and at least one cavity directly adjacent to one side of the optical element.

In step S02, a sleeve is provided.

In step S03, the optics module is inserted into the sleeve.

In step S04, a light-impermeable adhesive is inserted between the sleeve and the optics module, wherein the adhesive is spread between the sleeve and the optics module by means of the capillary effect and forms a aperture.

In particular, providing an optics module may comprise 3D printing of optics module 10, for example by local evaluation of a photoresist in a lithography system or a laser lithography system. Here, in particular, 2-photon absorption is used for local curing of the photoresist. The uncured photoresist is then removed. This produces a monolithic optics module 10, which consists in particular of a transparent polymer. This is then inserted into sleeve 14 according to step S03 and connected to sleeve 14 by means of a light-impermeable adhesive. In doing so, the adhesive spreads between sleeve 14 and optics module 10 by means of the capillary effect. At the same time, an aperture is created by the light-impermeable adhesive and in particular by providing an annular recess 18 in optics module 10, which is filled by the light-impermeable adhesive.

Sleeve 14 protects the mechanical stability of the complex structure of optics module 10. In this respect, the light-impermeable adhesive creates a firm connection between sleeve 14 and optics module 10. At the same time, the light-permeable adhesive and sleeve 14 prevent stray light from entering from the side. At the same time, the light-permeable adhesive forms a aperture. The imaging quality of the micro-optics is improved by providing a aperture and preventing stray light from entering from the side. The cavities ensure that there is a sufficient refractive index difference between the optical elements 16, 16′ and 16″ and the adjacent components to effectively refract light or control the light path within the micro-optics, respectively.

1. A micro-optics, in particular for connection to an optical fiber or a substrate, comprising
an optics module, wherein the optics module has at least one optical element and at least one cavity directly adjacent to one side of the optical element, and
a sleeve completely surrounding the optics module,
wherein the sleeve and the optics module are connected to one an-other with a light-impermeable adhesive, and
wherein the light-impermeable adhesive forms an aperture of the op-tics module.

2. The micro-optics according to claim 1, wherein a first end face of the optics module is directly connected to an optical fiber or a substrate.

3. The micro-optics according to claim 1, wherein an annular gap is formed between the optics module and the sleeve, wherein the annular gap is filled by the adhesive and in particular completely surrounds the optics module.

4. The micro-optics according to claim 1, wherein the optics module has spacer elements, wherein the spacer elements extend radially outwards and are in direct contact with the sleeve.

5. The micro-optics according to claim 1, wherein the sleeve is a metal sleeve and/or a light-impermeable sleeve.

6. The micro-optics according to claim 1, wherein the aperture is formed by an annular recess of the optics module which is filled by the adhesive.

7. The micro-optics according to claim 6, wherein the annular recess has a ventilation hole.

8. The micro-optics according to claim 1, wherein the adhesive is spread between the optics module and the sleeve by capillary force.

9. The micro-optics according to claim 1, wherein the at least one cavity has at least one opening.

10. The micro-optics according to claim 9, wherein a pressure in the at least one cavity substantially compensates for the capillary force of the adhesive.

11. The micro-optics according to claim 9, wherein the at least one opening has a contact element, wherein the contact element has a weakly wetting surface for suppressing the capillary effect of the adhesive.

12. The micro-optics according to claim 9, wherein the at least one opening has a contact element, wherein the contact element has an inclined surface for suppressing the capillary effect of the adhesive.

13. The micro-optics according to claim 12, wherein the inclined surface has an angle to the axial direction which is less than or equal to the contact angle of the adhesive.

14. A method for manufacturing micro-optics according to claim 1, comprising the following steps:
providing an optics module, wherein the optics module has at least one optical element and at least one cavity directly adjacent to one side of the optical element;
providing a sleeve;
inserting the optics module into the sleeve;
inserting a light-impermeable adhesive between the sleeve and the optics module, the adhesive spreading between the sleeve and the optics module by means of the capillary effect and forming an aperture.
